(19) United States
(12) Patent Application Publication
(10) Pub. No.: US 2025/0128516 A1
(43) Pub. Date: Apr. 24, 2025

(54) LIQUID EJECTING DEVICE

(71) Applicant: SEIKO EPSON CORPORATION, TOKYO (JP)

(72) Inventors: Yoshiyuki OKAZAWA, SHIOJIRI-SHI (JP); Katsumi YAMADA, Matsumoto-shi (JP)

(21) Appl. No.: 18/925,462

(22) Filed: Oct. 24, 2024

(30) Foreign Application Priority Data
Oct. 24, 2023 (JP) 2023-182375

(51) Int. Cl. B41J 2/17; B41J 2/165; B41J 29/46

(52) U.S. Cl. CPC B41J 2/1742; B41J 2/1652; B41J 29/46

(57) ABSTRACT

A liquid ejecting device includes: a liquid ejecting unit configured to eject a liquid onto a medium; a supporting portion disposed at a position that is opposed to the liquid ejecting unit to support the medium, the supporting portion including a first discharging hole through which the liquid is discharged downward; a liquid receiving section disposed lower than the supporting portion and configured to receive the liquid discharged from the first discharging hole; and a device body including the liquid ejecting unit, the supporting portion, and the liquid receiving section. When the device body is tilted from a first posture by a first angle, the liquid receiving section maintains its horizontality.

The present application is based on, and claims priority from JP Application Serial Number 2023-182375, filed Oct. 24, 2023, the disclosure of which is hereby incorporated by reference herein in its entirety.

### BACKGROUND

### 1. Technical Field

The present disclosure relates to a liquid ejecting device configured to eject a liquid onto a medium to perform recording.

### 2. Related Art

A recording device described in JP-A-2021-154702 includes a recording unit configured to perform recording on a medium, and also includes a supporting portion. The supporting portion includes a support face configured to support the medium, and a recessed portion recessed from the support face and disposed at a position corresponding to an end edge of the medium in the width direction. A liquid ejected to the recessed portion drops downward from a dropping hole formed in the supporting portion. An accepting section configured to accept the liquid dropped from the dropping hole is provided below the dropping hole. The accepting section includes an outlet port configured to cause the accepted liquid to flow out to a collecting section provided at the lower portion of the accepting section, and also includes a slope configured to lead the liquid to the outlet port.

In a case of the recording device described in JP-A-2021-154702, when the device is put in a tilted state, the angle of the slope at the accepting section changes. Thus, there is a possibility that the liquid spills over from the accepting section depending on the tilt angle of the device.

### SUMMARY

A liquid ejecting device according to the present disclosure used to solve the problem described above includes a liquid ejecting unit configured to eject a liquid onto a medium, a supporting portion disposed at a position that is opposed to the liquid ejecting unit to support the medium, the supporting portion including a first discharging hole through which the liquid is discharged downward, a liquid receiving section disposed lower than the supporting portion and configured to receive the liquid discharged from the first discharging hole, and a device body including the liquid ejecting unit, the supporting portion, and the liquid receiving section, in which when the device body is tilted from a first posture by a first angle, the liquid receiving section maintains horizontality.

### BRIEF DESCRIPTION OF THE DRAWINGS

FIG. 1 is a perspective view of the external appearance of a printer.

FIG. 2 is a diagram illustrating the main components of the printer.

FIG. 3 is a plan view of a supporting portion.

FIG. 4 is a diagram illustrating transition of tilts of the printer.

FIG. 5 is a diagram illustrating a posture of the supporting portion and a liquid receiving section when a device body is in a first posture.

FIG. 6 is a diagram illustrating a posture of the supporting portion and the liquid receiving section when the device body is tilted from the first posture by a first angle.

FIG. 7 is a diagram illustrating a posture of the supporting portion and the liquid receiving section when the device body is tilted from the first posture by 90°.

FIG. 8 is a diagram illustrating a structure of maintaining the horizontality of the liquid receiving section.

FIG. 9 is a diagram illustrating a structure of maintaining the horizontality of the liquid receiving section.

FIG. 10 is a diagram illustrating a structure of maintaining the horizontality of the liquid receiving section.

FIG. 11 is a diagram illustrating a structure of maintaining the horizontality of the liquid receiving section.

### DESCRIPTION OF EMBODIMENTS

Below, the present disclosure will be schematically described.

A liquid ejecting device according to a first aspect includes: a liquid ejecting unit configured to eject a liquid onto a medium; a supporting portion disposed at a position that is opposed to the liquid ejecting unit to support the medium, the supporting portion including a first discharging hole through which the liquid is discharged downward; a liquid receiving section disposed lower than the supporting portion and configured to receive the liquid discharged from the first discharging hole; and a device body including the liquid ejecting unit, the supporting portion, and the liquid receiving section, in which when the device body is tilted from a first posture by a first angle, the liquid receiving section maintains horizontality.

With the present aspect, when the device body is tilted from the first posture by the first angle, the liquid receiving section maintains the horizontality. This makes it possible to prevent the liquid from spilling over from the liquid receiving section.

A second aspect provides an aspect according to the first aspect, in which the liquid receiving section includes: a second discharging hole through which the received liquid is discharged downward; and a guide surface configured to be tilted relative to a horizontal direction when the device body is at least in the first posture, the guide surface being configured to guide the liquid to the second discharging hole.

With the present aspect, the liquid receiving section includes the guide surface configured to be tilted relative to the horizontal direction when the device body is at least in the first posture, the guide surface being configured to guide the liquid to the second liquid discharging hole. This makes it possible to smoothly discharge the received liquid.

A third aspect provides an aspect according to the first aspect, in which the supporting portion includes a recessed portion where the first discharging hole is formed, and the first discharging hole is provided at both ends, in a width direction, of the recessed portion, the width direction being a direction intersecting a medium transport direction.

With the present aspect, the first discharging hole is provided at both ends, in a width direction, of the recessed portion, the width direction being a direction intersecting a medium transport direction. This makes it possible to discharge the liquid from the first discharging hole even when, in the width direction, the device body is tilted in any directions.

Note that, in addition to the first aspect described above, the present aspect may be dependent from the second aspect described above.

A fourth aspect provides an aspect according to any one of the first aspect to the third aspect, the aspect including a base body configured to swingably support the liquid receiving section, in which the liquid receiving section swings to maintain a horizontal posture.

With the present aspect, since the liquid receiving section swings to maintain the horizontal posture, it is possible to easily achieve the configuration of maintaining the horizontality of the liquid receiving section.

A fifth aspect provides an aspect according to the fourth aspect, in which a position of a center of gravity of the liquid receiving section is on a vertical line passing through a center of swing.

With the present aspect, since the position of the center of gravity of the liquid receiving section is on the vertical line passing through the center of swing, it is possible to easily achieve the configuration of maintaining the horizontality of the liquid receiving section.

A sixth aspect provides an aspect according to the fifth aspect, in which the position of the center of gravity of the liquid receiving section is vertically lower than the center of swing.

With the present aspect, it is possible to obtain the operation and effect of the fifth aspect described above in a configuration in which the position of the center of gravity of the liquid receiving section is vertically lower than the center of swing.

In addition, when the device body is tilted, the liquid receiving section is able to maintain the horizontality due to the gravity.

A seventh aspect provides an aspect according to any one of the first aspect to the third aspect, including a shaft from which the liquid receiving section is hung, in which the liquid receiving section swings with the shaft being a center to maintain a horizontal posture.

With the present aspect, since the liquid receiving section swings with the shaft being a center to maintain the horizontal posture, it is possible to easily achieve the configuration of maintaining the horizontality of the liquid receiving section.

An eighth aspect provides an aspect according to any one of the first aspect to the third aspect, in which, when the device body is tilted, beyond a tilt at the first angle, up tp 90° with respect to a horizontal direction, a side surface, at an inner side, of the liquid receiving section is tilted so as to face upward with respect to the horizontal direction.

With the present aspect, when the device body is tilted, beyond a tilt at the first angle, up to 90° with respect to the horizontal direction, a side surface, at the inner side, of the liquid receiving section is tilted so as to face upward with respect to the horizontal direction. This makes it possible to prevent the liquid from spilling over from the liquid receiving section even when the device body is tilted, beyond a tilt at the first angle, up tp 90° with respect to the horizontal direction.

Note that the present aspect may be dependent from any one of the fourth aspect to the seventh aspect described above.

A ninth aspect provides an aspect according to any one of the first aspect to the third aspect, including: a tilt detecting unit used to detect a tilt of the device body; a notification unit configured to notify a user of information; and a control unit configured to receive information about the tilt detecting unit to control the notification unit, in which, when a tilt of the device body exceeds a threshold value, the control unit makes notification using the notification unit.

With the present aspect, since the control unit makes notification using the notification unit when the tilt of the device body exceeds the threshold value, it is possible to prevent the liquid from spilling over from the liquid receiving section.

Note that the present aspect may be dependent from any one of the fourth aspect to the eighth aspect described above.

A tenth aspect provides an aspect according to any one of the first aspect to the third aspect, in which the supporting portion includes a plurality of the first discharging holes, the device body includes a plurality of the liquid receiving sections that are independent of each other, and the plurality of the liquid receiving sections receive a liquid from the first discharging holes differing from each other.

With the present aspect, since the device body includes a plurality of the liquid receiving sections that are independent of each other, it is possible to reduce the amount of liquid that one of the liquid receiving sections receives. This makes it possible to prevent the liquid from spilling over from the liquid receiving section even when the liquid receiving section is not able to maintain the horizontality, and is tilted.

In addition, in a case where only one liquid receiving section is provided, the area occupied by the guide surface to swing increases in the vertical direction when the device body is tilted, which leads to an increase in the size of the device in the vertical direction. However, since a plurality of the liquid receiving sections are provided, it is possible to suppress an increase in the size of the device in the vertical direction.

Furthermore, it is possible to increase the swing angle of the liquid receiving section, and it is also possible to maintain the horizontality until further larger tilt angle. That is, it is possible to more effectively prevent the liquid from spilling over from the liquid receiving section.

Note that the present aspect may be dependent from any one of the fourth aspect to the ninth aspect.

An eleventh aspect provides an aspect according to the tenth aspect, in which a plurality of the first discharging holes and a plurality of the liquid receiving sections are provided along a width direction that is a direction intersecting a medium transport direction.

With the present aspect, it is possible to obtain the operation and effect of the tenth aspect described above in a configuration in which a plurality of the first discharging holes and a plurality of the liquid receiving sections are provided along the width direction that is a direction intersecting the medium transport direction.

A twelfth aspect provides an aspect according to the eleventh aspect, in which the supporting portion includes a recessed portion where the first discharging hole is formed, and a plurality of the recessed portions that are independent of each other are provided along the width direction.

With the present aspect, since a plurality of the recessed portions that are independent of each other are provided along the width direction, the liquid ejected to the supporting portion does not concentrate on one location when the device body is tilted from the first posture, and it is possible to prevent the liquid from spilling over from the supporting portion.

Below, the present disclosure will be specifically described.

Hereinbelow, as one example of a liquid ejecting device, description will be made of an inkjet printer 1 configured to eject ink serving as one example of a liquid onto a medium typified by a recording sheet, thereby performing recording. Hereinbelow, the inkjet printer 1 is simply referred to as a printer 1.

Note that the X-Y-Z coordinate system illustrated in each of the drawings is an orthogonal coordinate system, and the X-axis direction is a direction intersecting a transport direction of a medium, that is, is a medium width direction, and is the width direction of the device. Of the X-axis direction, the +X direction is a left direction when viewed toward the front face of the device, and the −X direction is a right direction when viewed toward the front face of the device.

In addition, the Y-axis direction is a depth direction of the device. Of the Y-axis direction, the +Y direction is a direction from the back surface of the device toward the front face of the device, and the −Y direction is a direction from the front face of the device toward the back surface of the device.

The Z-axis direction is a vertical direction, and is a direction normal to the installation surface G of the printer 1, that is, is the height direction of the device. Of the Z-axis direction, the +Z direction is an upward direction, the−Z direction is a downward direction.

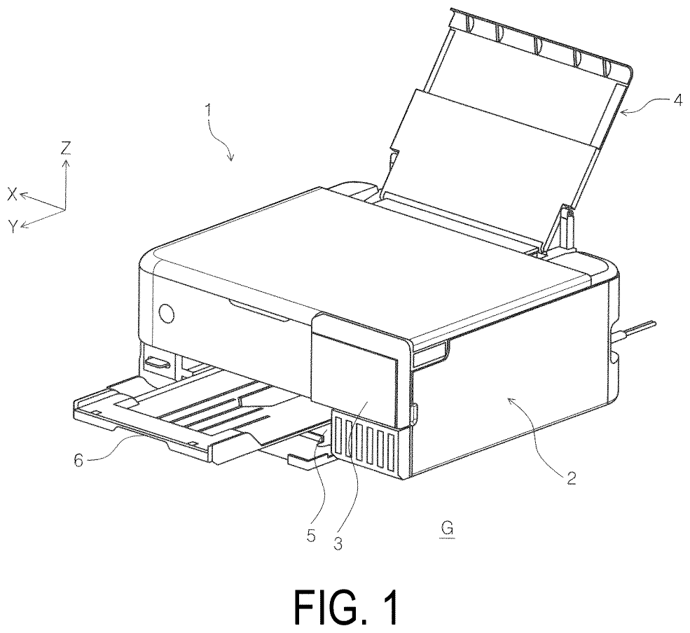

In FIG. 1, the printer 1 includes a rear paper-feed tray 4 disposed at a rear portion of the device body 2 and configured to support a medium in a tilted posture. The medium placed on the rear paper-feed tray 4 is fed by a paper feed unit (not illustrated) toward the +Y direction. In addition, a front paper-feed tray 5 configured to set a medium in a horizontal posture is provided at the bottom of the device body 2. The medium set on the front paper-feed tray 5 is fed by the paper feed unit (not illustrated) toward the −Y direction. Then, the medium is inverted to face upward, and is transported toward the +Y direction.

An operating panel 3 used to perform various types of operational setting is provided at the front face of the device body 2. In addition, a paper discharge tray 6 configured to receive a medium on which recording is performed and that is discharged in the +Y direction is provided in the front face of the device body 2. The paper discharge tray 6 is provided so as to be able to switch between a state (not illustrated) of being accommodated in the device body 2 and a state of protruding from the device body 2 as illustrated in FIG. 1.

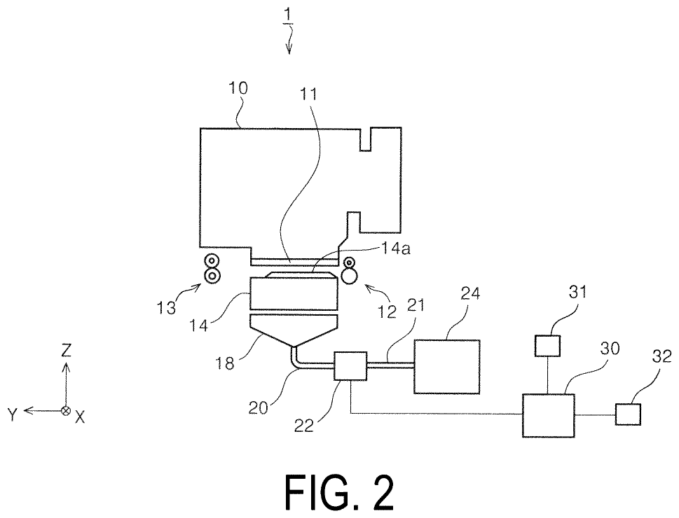

FIG. 2 illustrates the configuration of a liquid ejecting head 11 and its surroundings. The liquid ejecting head 11 is provided within the device body 2. A medium fed from the rear paper-feed tray 4 or the front paper-feed tray 5 described above is transported toward the +Y direction by a transport roller pair 12.

On the medium transported by the transport roller pair 12, ink is ejected by the liquid ejecting head 11 serving as one example of a liquid ejecting unit, thereby performing recording. The liquid ejecting head 11 is provided at a carriage 10. The carriage 10 is provided so as to be able to move in the X-axis direction. When the carriage 10 moves in the X-axis direction, the liquid ejecting head 11 ejects ink onto the medium. However, the liquid ejecting head 11 may be a line head that includes an ink ejecting nozzle (not illustrated) provided throughout the whole of the X-axis direction, and performs recording without moving in the X-axis direction.

The medium on which recording has been performed is discharged onto the paper discharge tray 6 (see FIG. 1) by a discharge roller pair 13.

A supporting portion 14 is provided at a position that is opposed to the liquid ejecting head 11. The supporting portion 14 is configured to support a medium at the position that is opposed to the liquid ejecting head 11 and define a space between the medium and the liquid ejecting head 11.

As described in detail later, the printer 1 is able to perform borderless printing in which recording is performed with no margin being provided at end sides of the medium, and the supporting portion 14 receives ink ejected and landing on a region outside of the end sides of the medium. The ink that the supporting portion 14 receives drops downward from the supporting portion 14. A liquid receiving section 18 is provided lower than the supporting portion 14. The liquid receiving section 18 receives the ink dropping from the supporting portion 14.

Note that the supporting portion 14 may receive ink other than the ink ejected and landing on a region outside of the end sides of the medium, or the liquid receiving section 18 may receive ink other than the ink dropping from the supporting portion 14. The supporting portion 14 or the liquid receiving section 18 may receive ink discharged in association with maintenance of the liquid ejecting head 11.

The device body 2 includes the liquid ejecting head 11, the supporting portion 14, and the liquid receiving section 18 described above. Note that, as described in detail later, the device body 2 serves as one example of a base body configured to swingably support the liquid receiving section 18.

One end of a tube 20 is coupled to the liquid receiving section 18. A pump 22 is coupled to the other end of the tube 20, and as the pump 22 is activated, ink is sucked from the liquid receiving section 18. In addition, one end of the tube 21 is coupled to the pump 22. The other end of the tube 21 is coupled to a liquid collecting container 24. The ink sucked from the liquid receiving section 18 is collected by the liquid collecting container 24. The pump 22 is controlled by a control unit 30.

The control unit 30 includes a CPU (not illustrated), a non-volatile memory, and the like. Various types of control programs for the printer 1 are stored in the non-volatile memory, and are read out by the CPU to be implemented.

The control unit 30 is coupled to a tilt sensor 31 serving as one example of a tilt detecting unit used to detect a tilt of the device body 2. In the present embodiment, the tilt sensor 31 is a uniaxial sensor configured to detect a tilt of the device body 2 around the Y-axis.

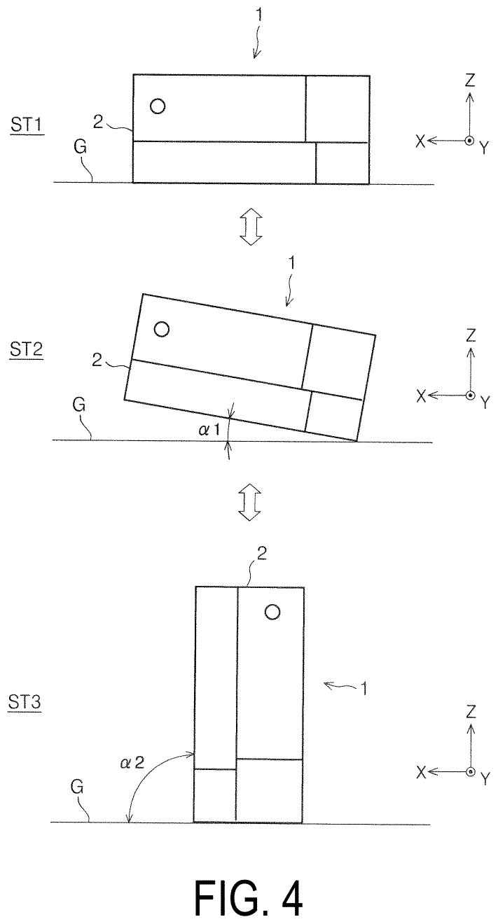

The state ST1 in FIG. 4 is a state where the device body 2 is installed on the installation surface G that is a horizontal surface to maintain the horizontal posture. The horizontal posture of the device body 2 serves as one example of a first posture. In addition, the state ST2 in FIG. 4 is a state where the device body 2 is tilted by an angle α1 from the first posture, that is, from the horizontal posture as viewed from the Y-axis direction. The angle α1 serves as one example of a first angle. Furthermore, the state ST3 in FIG. 4 is a state where the device body 2 is further tilted from the state ST2 and is tilted by an angle α2 with respect to the horizon as viewed from the Y-axis direction. The angle α2 is 90° as one example.

Note that the tilt sensor 31 may be a sensor that makes it possible to detect a tilt of the device body 2 around the X-axis, rather than around the Y-axis. In addition, the tilt sensor 31 may be a dual-axis sensor that makes it possible detect a tilt of the device body 2 around the X-axis, in addition to around the Y-axis. For the tilt sensor 31, it is possible to use an electrical capacitance type sensor, a pendulum-type sensor, a quartz-crystal type sensor, or other various types of sensors.

Furthermore, a notification unit 32 is coupled to the control unit 30. The notification unit 32 serves as one example of a notification unit configured to notify a user of information. For the notification unit 32, it is possible to employ a speaker that produces sound, a display unit that displays various types of information, and the like. When the operating panel 3 (see FIG. 1) includes the display unit, it may be possible to employ this display unit as the notification unit 32.

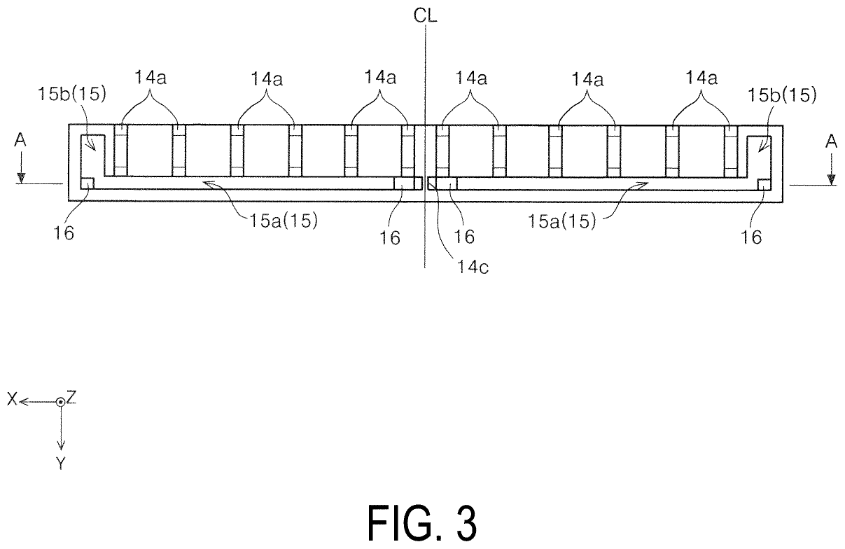

FIG. 3 is a plan view of the supporting portion 14. The supporting portion 14 includes a plurality of ribs 14a each extending along the Y-axis direction and disposed at appropriate intervals along the X-axis direction. The transported medium is supported by the ribs 14a.

In FIG. 3, the line indicated by the reference character CL is parallel to the Y-axis direction, and is a center line passing through the center, in the X-axis direction, that is, the width direction of the medium. The ribs 14a are arranged at positions that make them axially symmetric in the X-axis direction with the center line CL being the symmetrical axis.

Furthermore, the supporting portion 14 includes a wall portion 14c formed at a position through which the center line CL passes. A recessed portion 15 is formed at both sides of the wall portion 14c in the X-axis direction. The recessed portion 15 is disposed so as to be axially symmetric with the center line CL being the symmetrical axis in the X-axis direction. In other words, a plurality of the recessed portions 15 are provided along the X-axis direction. In other words, the plurality of recessed portions 15 are separated by the wall portion 14c.

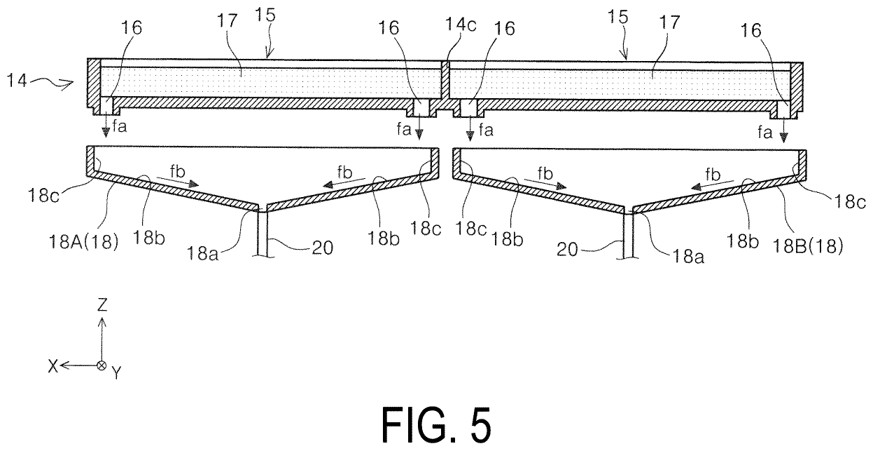

Note that a first liquid absorbing member 17 configured to absorb ink is provided at the recessed portion 15 as illustrated in FIGS. 5 to 7, although illustration thereof is not given in FIG. 3.

The recessed portion 15 includes a first portion 15a extending in the X-axis direction, and a second portion 15b extending in the Y-axis direction. The second portion 15b is provided at a position through which an end side, in the X-axis direction, of a medium passes.

By ejecting ink to a region outside of the end side, in the X-axis direction, of a medium, it is possible to perform borderless recording in a region of the end side, in the X-axis direction, of the medium. At this time, the ink ejected to the region outside of the end side, in the X-axis direction, of the medium is received by the second portion 15b of the recessed portion 15.

In addition, when the leading end or the trailing end of a medium is on the first portion 15a, by ejecting ink to a region outside of the leading end or the trailing end of the medium, it is possible to perform borderless recording in the leading-end region or the trailing-end region of the medium. At this time, the ink ejected to the region outside of the leading end or the trailing end of the medium is received by the first portion 15a of the recessed portion 15.

A first discharging hole 16 configured to discharge ink downward is formed in the bottom of the recessed portion 15. The ink ejected to the recessed portion 15 is discharged downward from the first discharging hole 16.

In the present embodiment, a plurality of the first discharging holes 16 are provided for one recessed portion 15. In the present embodiment, the first discharging hole 16 is provided at both end portions, in the X-axis direction, of one recessed portion 15.

However, the position of the first discharging hole 16 is not limited to this. By disposing the first discharging hole 16 close to a location of the recessed portion 15 that receives the ink, it is possible to more quickly discharge, from the first discharging hole 16, the ink ejected to the recessed portion 15. In addition, it is possible to prevent the ink from spilling over from the supporting portion 14 when the device body 2 is tilted.

Note that it may be possible to form the bottom surface of the second portion 15b so as to slope downward toward the +Y direction. This makes it possible to cause the ink ejected to the second portion 15b to smoothly flow to the first discharging hole 16. In addition, it may be possible to form the bottom surface of the first portion 15a so as to slope downward toward either one of two first discharging holes 16 spaced apart from each other in the X-axis direction. Alternatively, it may be possible to form the bottom surface of the first portion 15a such that the highest portion is between two first discharging holes 16 spaced apart from each other in the X-axis direction, and form this bottom surface so as to slope downward toward these two first discharging holes 16. This makes it possible to cause the ink ejected to the first portion 15a to smoothly flow to the first discharging hole 16.

The recessed portion 15 includes the first liquid absorbing member 17 as illustrated in FIGS. 5 to 7. It may be possible to form the first liquid absorbing member 17 of any material provided that the material is able to absorb ink. For example, it is possible to use sponge, nonwoven fabric, or the like, for example.

The first liquid absorbing member 17 may include a plurality of first liquid absorbing members 17 provided in the X-axis direction, that is, in the width direction of a medium, or may include a plurality of first liquid absorbing members 17 provided in the Y-axis direction, that is, in the medium transport direction, or may include a plurality of first liquid absorbing members 17 provided in both the X-axis direction and the Y-axis direction. Note that, in the present embodiment, the plurality of first liquid absorbing members 17 are provided along the width direction that is a direction intersecting the medium transport direction. Such a configuration makes it possible to reduce the amount of liquid absorbed by each of the first liquid absorbing members 17. Thus, when the device body 2 is tilted to tilt the first liquid absorbing members 17, it is possible to prevent the ink from spilling over from the first liquid absorbing members 17. In other words, it is desirable that the first liquid absorbing member 17 should have a length that makes it possible to keep holding the ink held by one first liquid absorbing member 17 in the horizontal state even when the device body 2 is tilted 90°.

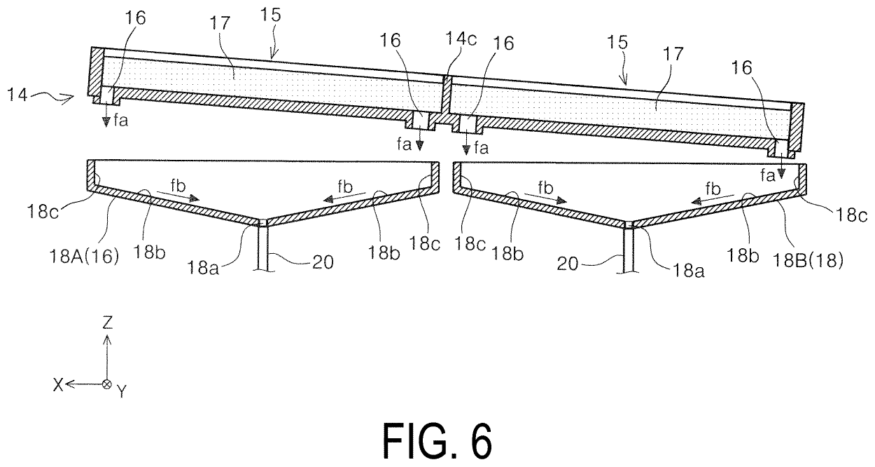

As indicated by the arrow fa in FIGS. 5 and 6, the ink discharged downward from the first discharging hole 16 is received by the liquid receiving section 18. The liquid receiving section 18 includes a plurality of liquid receiving sections 18 provided along the X-axis direction. In the present embodiment, a first liquid receiving section 18A and a second liquid receiving section 18B are provided as the liquid receiving sections 18. Note that the first liquid receiving section 18A and the second liquid receiving section 18B are collectively referred to as a liquid receiving section 18 when they do not need to be distinguished.

The first liquid receiving section 18A receives ink discharged from the recessed portion 15 disposed at the +X direction relative to the wall portion 14c. The second liquid receiving section 18B receives ink discharged from the recessed portion 15 disposed at the −X direction relative to the wall portion 14c.

The liquid receiving section 18 includes a second discharging hole 18a used to discharge downward the received ink. In addition, the liquid receiving section 18 includes a guide surface 18b sloped with respect to the horizontal direction when the device body 2 is at least in the horizontal posture. The guide surface 18b is configured to guide ink to the second discharging hole 18a. Note that, in FIG. 5, the guide surface 18b is sloped with respect to the X-axis direction. However, the guide surface 18b may be also sloped with respect to the Y-axis direction to be formed into a cone shape as a whole. That is, the liquid receiving section 18 may be formed into a funnel shape.

The tube 20 described above is coupled to the second discharging hole 18a.

Note that, in the embodiment illustrated in FIGS. 5 to 7, the liquid absorbing member is not provided at the inner side of the liquid receiving section 18. However, the liquid absorbing member may be provided at the inner side of the liquid receiving section 18. This suppresses idle suction when the ink is sucked by the pump 22, facilitating suction of the ink. Note that, for this liquid absorbing member, it may be possible to use sponge, nonwoven fabric, or the like. In addition, at this time, as the liquid absorbing member, it may be possible to use a member having more favorable liquid fluidity than the first liquid absorbing member 17 described above.

The liquid receiving section 18 is configured so as to maintain the horizontality at least when the device body 2 is between the state ST1 and the state ST2 in FIG. 4. In other words, the liquid receiving section 18 is configured so as to maintain the posture of the state ST1 even when the device body 2 changes between the state ST1 and the state ST2 in FIG. 4. The configuration of maintaining the horizontality of the liquid receiving section 18 will be described later.

Note that, in the present description, the term “horizontality” not only includes complete horizon but also includes a case of being substantially the horizon in consideration of measurement errors, and a case of being substantially the horizon in consideration of manufacturing variations of members.

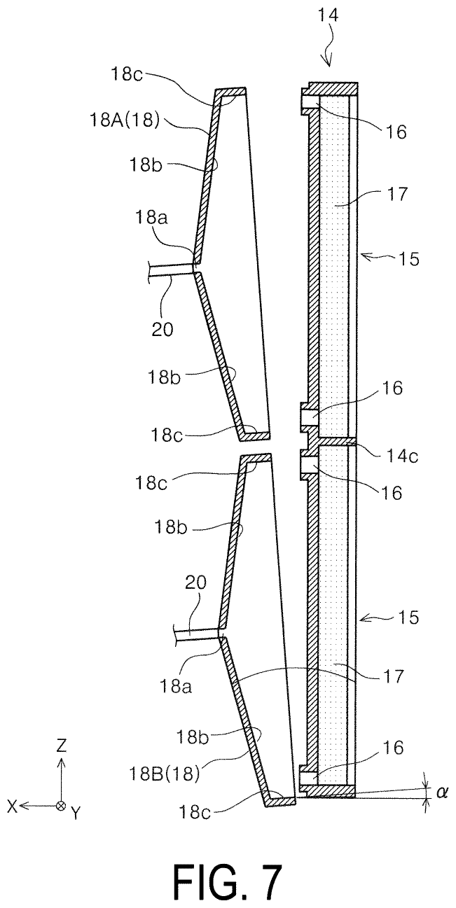

FIG. 5 is a diagram corresponding to the state ST1 in FIG. 4. FIG. 6 is a diagram corresponding to the state ST2 in FIG. 4. FIG. 7 is a diagram corresponding to the state ST3 in FIG. 4. The liquid receiving section 18 maintains the horizontality as illustrated in FIG. 6 even when the device body 2 is tilted from the first posture by the angle α1 as indicated in the state ST2 of FIG. 4. Here, the angle α1 may be an appropriate value that falls in a range of more than 0° and not more than 90°. This makes it possible to prevent ink from spilling over from the liquid receiving section 18.

In addition, in the present embodiment, the liquid receiving section 18 includes the second discharging hole 18a configured to discharge downward the received ink, and also includes the guide surface 18b sloped with respect to the horizontal direction when the device body 2 is at least in the first posture and configured to guide a liquid to the second discharging hole 18a. The guide surface 18b enables the received ink to be smoothly discharged.

Furthermore, in the present embodiment, the supporting portion 14 includes the recessed portion 15 where the first discharging hole 16 is formed. The first discharging hole 16 is provided at both end portions, in the X-axis direction, of the recessed portion 15. This makes it possible to discharge the ink from the first discharging hole 16 even when, in the width direction, the device body 2 is tilted in any directions. Thus, it is possible to prevent the ink from spilling over from the supporting portion 14 when the device body 2 is tilted.

In addition, in the present embodiment, when the device body 2 is tilted by 90° with respect to the horizontal direction beyond a tilt at the angle α1, a side surface 18c, at the inner side, of the liquid receiving section 18 is tilted so as to face upward with respect to the horizontal direction as illustrated in FIG. 7. In other words, when the device body is in the horizontal posture, the side surface 18c is tilted toward the inner side of the liquid receiving section with respect to the vertical direction. The angle α illustrated in FIG. 7 indicates the tilt angle at which the side surface 18c is tilted with respect to the horizontal direction.

This makes it possible to prevent the liquid from spilling over from the liquid receiving section 18 even when the device body 2 is tilted by 90° with respect to the horizontal direction beyond a tilt at the angle α1.

In other words, when the tilt of the device body 2 is increased from the angle α1, it may be possible that the horizontality cannot be maintained, although the liquid receiving section 18 swings in a direction in which the horizontality is maintained. That is, when the tilt of the device body 2 is at the angle α2, it may be possible that the horizontality cannot be maintained, although the liquid receiving section 18 swings in a direction in which the horizontality is maintained. One example of factors that cause this includes interference between the liquid receiving section 18 and other members, or the like.

Here, the angle α2 may be an appropriate value that falls in a range of more than the angle α1 and not more than 90°. The angle at which the horizontality cannot be maintained although the liquid receiving section 18 swings in a direction in which the horizontality is maintained may be an appropriate value that falls in a range of more than the angle α1 and not more than 90°.

Furthermore, in the present embodiment, the printer 1 includes the tilt sensor 31 configured to detect a tilt of the device body 2, and also includes the notification unit 32 configured to notify a user of information, as described with reference to FIG. 2. In addition, when the tilt of the device body 2 exceeds a threshold value, the control unit 30 configured to receive information from the tilt sensor 31 to control the notification unit 32 causes the notification unit 32 to make notification to that effect. This makes it possible to prevent the liquid from spilling over from the liquid receiving section 18. Note that, for the notification made by the notification unit 32, it may be possible to employ a warning sound as one example when the notification unit 32 is configured by a speaker, or employ a warning message when the notification unit 32 is a display unit that makes it possible to achieve various types of display.

Note that it is possible to set the threshold value described above to an appropriate value equal to or less than 90°.

Note that the control unit 30 controls the pump 22 as described above. After performing borderless printing to a medium, the control unit 30 is able to drive the pump 22 for a predetermined period of time, for example.

Note that, in the present embodiment, the first liquid receiving section 18A and the second liquid receiving section 18B, that is, a plurality of the liquid receiving sections 18 are coupled to one pump 22. However, it may be possible to suck each of the plurality of liquid receiving sections 18 by using a separate pump. This makes it possible to more reliably suck ink from the liquid receiving section 18.

In addition, it may be possible to employ a configuration in which a valve mechanism is provided between one pump 22 and the plurality of liquid receiving sections 18, and a liquid receiving section 18 to be sucked can be selected from among the plurality of liquid receiving sections 18. This makes it possible to more reliably suck ink from the liquid receiving section 18.

Furthermore, in the present embodiment, a plurality of the first discharging holes 16 are provided in the supporting portion 14. In addition, in the present embodiment, the device body 2 includes a plurality of liquid receiving sections 18 that are independent of each other. Furthermore, the plurality of liquid receiving sections 18 each receive a liquid from a different first discharging hole 16.

In this manner, the printer 1 includes the plurality of liquid receiving sections 18 that are independent of each other. This makes it possible to reduce the amount of ink that one liquid receiving section 18 receives. Thus, it is possible to prevent the ink from spilling over from the liquid receiving section 18 even when the liquid receiving section 18 is not able to maintain the horizontality, and is tilted.

In addition, in a case where only one liquid receiving section 18 is provided, the area occupied by the guide surface 18b to swing increases in the vertical direction. This leads to an increase in the size of the device in the vertical direction. However, since a plurality of the liquid receiving sections 18 are provided, it is possible to suppress an increase in the size of the device in the vertical direction.

Furthermore, it is possible to increase the swing angle of the liquid receiving section 18, and it is also possible to maintain the horizontality until further larger tilt angle. In addition, the posture of the liquid receiving section 18 when the device body 2 is tilted by 90° can be brought close to the horizon. That is, it is possible to further effectively prevent a liquid from spilling over from the liquid receiving section 18.

Note that the number of liquid receiving sections 18 is not limited two, and three or more liquid receiving sections 18 may be provided. Furthermore, a plurality of liquid receiving sections 18 may be provided in the X-axis direction, that is, in the medium width direction, or may be provided in the Y-axis direction, that is, in the medium transport direction, or may be provided in both the X-axis direction and the Y-axis direction.

Note that, in the present embodiment, the plurality of first discharging holes 16 and the plurality of liquid receiving sections 18 are provided along the width direction that is a direction intersecting the medium transport direction.

In addition, in the present embodiment, the supporting portion 14 includes the recessed portion 15 including the first discharging hole 16. Furthermore, a plurality of the recessed portions 15 that are independent of each other are provided along the width direction. Thus, the ink ejected to the supporting portion 14 does not concentrate on one location when the device body 2 is tilted from the horizontal posture, and it is possible to prevent the ink from spilling over from the supporting portion 14.

Note that, in the present embodiment, the first liquid receiving section 18A collects ink ejected to the region outside of the end portion, at the +X direction, of the medium. In addition, the second liquid receiving section 18B collects ink ejected to the region outside of the end portion, at the −X direction, of the medium.

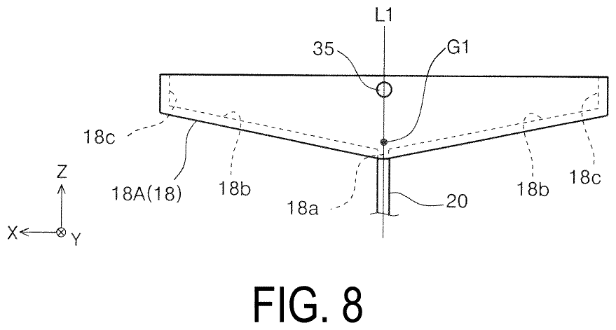

Next, description will be made of a configuration of maintaining the horizontality of the liquid receiving section 18. Note that, while FIGS. 8 to 11 each illustrate a configuration of maintaining the horizontality of the first liquid receiving section 18A provided at the +X direction, a configuration of maintaining the horizontality of the second liquid receiving section 18B provided at the −X direction is similar to this, and hence, illustration thereof will not be given. In FIG. 8, the liquid receiving section 18 swings relative to the device body 2 with a shaft 35 extending in the Y-axis direction being a swing axis to maintain the horizontal posture. Hereinafter, the “swing” of the liquid receiving section 18 means relative swinging with respect to the device body 2.

Note that the shaft 35 is provided at a frame (not illustrated) that constitutes the device body 2. With such a configuration, it is possible to easily achieve the configuration of maintaining the horizontality of the liquid receiving section 18. Note that the liquid receiving section 18 may be swingable relative to the shaft 35, and may be swingable together with the shaft 35. In a case of a configuration in which the liquid receiving section 18 is swingable relative to the shaft 35, a rolling bearing may be employed between the liquid receiving section 18 and the shaft 35.

Note that, although the liquid receiving section 18 is configured to swing around the Y-axis, it may be possible to employ a configuration of swinging around the X-axis or a configuration of swinging around both the Y-axis and the X-axis. This similarly applies to a liquid receiving section 18 according to another embodiment described below.

In addition, the first liquid receiving section 18A and the second liquid receiving section 18B may be configured to each swing independently of each other, or may be configured to swing in an integral manner. That is, the plurality of liquid receiving sections 18 may each swing independently of each other, or a portion of or all of the plurality of liquid receiving sections 18 may swing in an integral manner. This similarly applies to a liquid receiving section 18 according to another embodiment described below.

Furthermore, in FIG. 8, the reference character G1 represents a position of the center of gravity of the liquid receiving section 18. In the present embodiment, the position G1 of the center of gravity of the liquid receiving section 18 is on a vertical line L1 passing through the center of swing. This makes it possible to easily achieve the configuration of maintaining the horizontality of the liquid receiving section 18.

Note that, in the present embodiment, the position G1 of the center of gravity of the liquid receiving section 18 is vertically lower than the shaft 35, that is, the center of swing.

However, the position G1 of the center of gravity of the liquid receiving section 18 and the center of swing may exist at the same position, or the position G1 of the center of gravity may exist vertically higher than the center of swing.

In addition, the center of swing of the liquid receiving section 18 may be disposed at the center position, in the vertical direction, of the liquid receiving section 18. Alternatively, the center of swing of the liquid receiving section 18 may is vertically lower than the center position, in the vertical direction, of the liquid receiving section 18. Alternatively, the center of swing of the liquid receiving section 18 may exist vertically higher than the center position, in the vertical direction, of the liquid receiving section 18.

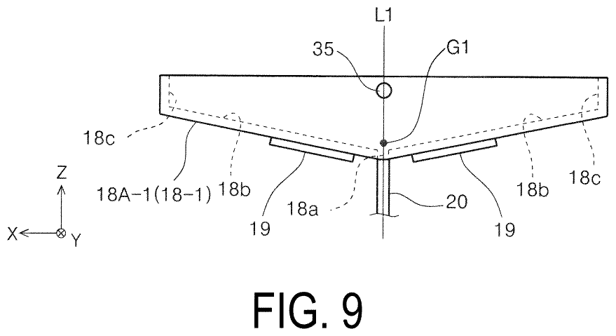

Next, FIG. 9 illustrates a first liquid receiving section 18A-1, that is, a liquid receiving section 18-1 according to another embodiment. The liquid receiving section 18-1 includes a lower surface provided with a weight 19. The weight 19 is comprised of a metal plate member, as one example. The weight 19 is provided at both sides of the vertical line L1 in the X-axis direction.

With the weight 19 being provided, it is possible to lower the position G1 of the center of gravity, which makes it possible to more reliably maintain the horizontal posture of the liquid receiving section 18-1 when the device body 2 is tilted.

In addition, by adjusting the position of the weight 19, it is possible to adjust the horizontal balance of the liquid receiving section 18-1.

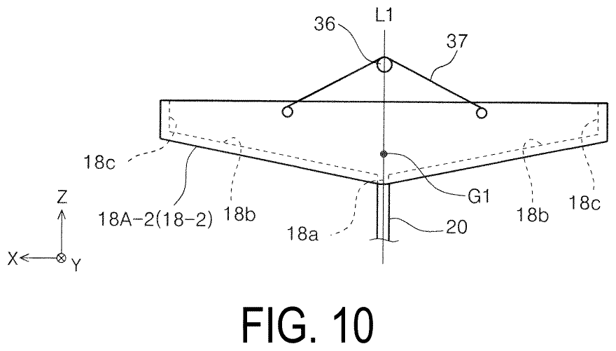

Next, FIG. 10 illustrates a first liquid receiving section 18A-2, that is, a liquid receiving section 18-2 according to another embodiment. In the present embodiment, the printer 1 includes a shaft 36 from which the liquid receiving section 18-2 is hung. The liquid receiving section 18-2 is hung down through a hanging belt 37 hung on the shaft 36 extending in the Y-axis direction. The shaft 36 is pivotally supported in a rotatable manner relative to the frame (not illustrated) that constitutes the device body 2. The hanging belt 37 is provided at both sides of a liquid receiving section 38-2 in the Y-axis direction.

In addition, the liquid receiving section 18-2 swings with the shaft 36 being the center to maintain the horizontal posture. Such a configuration makes it possible to easily achieve the configuration of the maintaining the horizontality of the liquid receiving section 18-2.

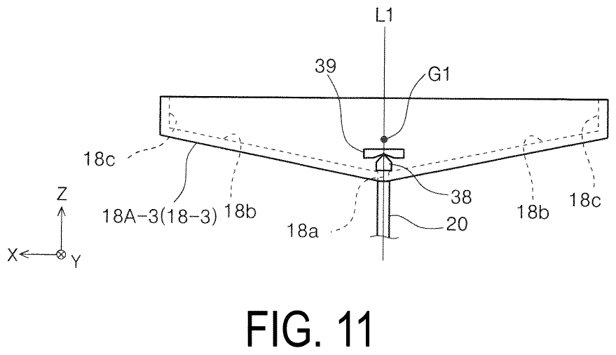

Next, FIG. 11 illustrates a first liquid receiving section 18A-3, that is, a liquid receiving section 18-3 according to another embodiment. In the present embodiment, the printer 1 includes a supporting portion 38 configured to support the liquid receiving section 18-3 in a swingable manner. An upper end portion of the supporting portion 38 is formed into a protruding shape that protrudes vertically upward. However, the upper end portion of the supporting portion 38 may be formed into an R-shape.

The liquid receiving section 18-3 includes a supported portion 39 supported by the supporting portion 38. The lower side of the supported portion 39 has a recessed shape so as to receive the supporting portion 38. The supporting portion 38 and the supported portion 39 are provided at both sides of a liquid receiving section 38-3 in the Y-axis direction.

In addition, the liquid receiving section 18-3 swings with the center being a portion supported by the supporting portion 38 to maintain the horizontal posture. With such a configuration, it is possible to easily achieve the configuration of maintaining the horizontality of the liquid receiving section 18-3.

Note that, in the present embodiment, the position G1 of the center of gravity is vertically higher than the contact position between the supporting portion 38 and the supported portion 39.

It is needless to say that the present disclosure is not limited to the embodiments or modification examples described above, and various modifications are possible within the scope of the present disclosure as described in the claims, which also fall within the scope of the present disclosure.

What is claimed is:

1. A liquid ejecting device comprising:
a liquid ejecting unit configured to eject a liquid onto a medium;
a supporting portion disposed at a position that is opposed to the liquid ejecting unit to support the medium, the supporting portion including a first discharging hole through which the liquid is discharged downward;
a liquid receiving section disposed lower than the supporting portion and configured to receive the liquid discharged from the first discharging hole; and
a device body including the liquid ejecting unit, the supporting portion, and the liquid receiving section, wherein
when the device body is tilted from a first posture by a first angle, the liquid receiving section maintains horizontality.

2. The liquid ejecting device according to claim 1, wherein
the liquid receiving section includes:
a second discharging hole through which the received liquid is discharged downward; and
a guide surface configured to be tilted relative to a horizontal direction when the device body is at least in the first posture, the guide surface being configured to guide the liquid to the second discharging hole.

3. The liquid ejecting device according to claim 1, wherein
the supporting portion includes a recessed portion where the first discharging hole is formed, and
the first discharging hole is provided at each of both ends, in a width direction, of the recessed portion, the width direction being a direction intersecting a medium transport direction.

4. The liquid ejecting device according to claim 1 further comprising:
a base body configured to swingably support the liquid receiving section, wherein
the liquid receiving section swings to maintain a horizontal posture.

5. The liquid ejecting device according to claim 4, wherein
a position of a center of gravity of the liquid receiving section is on a vertical line passing through a center of swing.

6. The liquid ejecting device according to claim 5, wherein
the position of the center of gravity of the liquid receiving section is vertically lower than the center of swing.

7. The liquid ejecting device according to claim 1 further comprising:
a shaft from which the liquid receiving section is hung, wherein
the liquid receiving section swings with the shaft being a center to maintain a horizontal posture.

8. The liquid ejecting device according to claim 1, wherein
when the device body is tilted, beyond a tilt at the first angle, up to 90° with respect to a horizontal direction, a side surface, at an inner side, of the liquid receiving section is tilted so as to face upward with respect to the horizontal direction.

9. The liquid ejecting device according to claim 1 further comprising:
a tilt detecting unit used to detect a tilt of the device body;
a notification unit configured to notify a user of information; and
a control unit configured to receive information about the tilt detecting unit to control the notification unit, wherein
when a tilt of the device body exceeds a threshold value, the control unit makes notification using the notification unit.

10. The liquid ejecting device according to claim 1, wherein
the supporting portion includes a plurality of the first discharging holes,
the device body includes a plurality of the liquid receiving sections that are independent of each other, and
the plurality of the liquid receiving sections receive a liquid from the first discharging holes differing from each other.

11. The liquid ejecting device according to claim 10, wherein
a plurality of the first discharging holes and a plurality of the liquid receiving sections are provided along a width direction that is a direction intersecting a medium transport direction.

12. The liquid ejecting device according to claim 11, wherein
the supporting portion includes a recessed portion where the first discharging hole is formed, and
a plurality of the recessed portions that are independent of each other are provided along the width direction.
